(19) United States
(12) Patent Application Publication
(10) Pub. No.: US 2010/0087608 A1
(43) Pub. Date: Apr. 8, 2010

(54) METHOD OF PRODUCING VINYL CHLORIDE-BASED POLYMER

(75) Inventors: Kiyoshi ENDO, Osaka-shi (JP); Yoshikatsu TSUCHIYA, Osaka-shi (JP); Makoto OOURA, Lake Jackson, TX (US); Hideaki ISHIZU, Kamisu-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: Osaka City University, Osaka-shi (JP); Shin -Etsu Chemical Co., Ltd., Chiyoda-ku (JP)

(21) Appl. No.: 12/555,247

(22) Filed: Sep. 8, 2009

(30) Foreign Application Priority Data
Oct. 2, 2008 (JP) 2008-257135

(51) Int. Cl. C08F 4/42

(52) U.S. Cl. 526/135; 526/160

(57) ABSTRACT

A method that is capable of producing a vinyl chloride-based polymer having excellent thermal stability without sacrificing productivity is provided. The method includes polymerizing a vinyl chloride-based monomer in the presence of a vanadium compound (A) represented by formula: Vⁱ(═O)ⱼZₖ (wherein i is an integer of 2 to 5, j represents 0 or 1, Z represents a ligand such as is an organic ligand that can bond to the vanadium atom via a hetero atom, and a plurality of ligands Z may be bonded together to form a ring that also includes the vanadium atom as a member of the ring, and k is an integer from 1 to 5), and in the presence of at least one aluminum compound (B).

### BACKGROUND OF THE INVENTION

1. Field of the Invention

The present invention relates to a novel production method, which uses a specific vanadium compound and a specific aluminum compound, and is capable of producing a vinyl chloride-based polymer having excellent thermal stability at a favorable level of productivity.

2. Description of the Prior Art

Vinyl chloride-based polymers are conventionally produced by a suspension polymerization method using a typical radical polymerization initiator, and these vinyl chloride-based polymers are widely used in all manner of fields as cheap thermoplastics that exhibit excellent physical properties and mechanical properties. However, a vinyl chloride-based polymer obtained using the type of conventional method described above includes abnormal structures such as head-to-head bonds and branched structures, and these abnormal structures tend to cause a marked deterioration in the thermal stability of the vinyl chloride-based polymer.

In order to address this drawback, for example, a polymerization method that uses a half-titanocene compound has been proposed (Polymer, 49 (2008), pp. 1180 to 1184). However, although a vinyl chloride-based polymer obtained using this polymerization method exhibits improved thermal stability compared with a vinyl chloride-based polymer obtained via a conventional radical polymerization, the polymerization rate, the catalytic activity and the yield are all low, meaning the level of productivity is not particularly favorable. Further, this polymerization method requires the use of a large amount of methylaluminoxane, which is considerably more expensive than vanadium compounds, meaning the method is not very attractive from an economic perspective.

### SUMMARY OF THE INVENTION

The present invention has been developed in light of the above problems associated with the conventional technology, and has an object of providing a method that is capable of producing a vinyl chloride-based polymer having excellent thermal stability without sacrificing productivity.

As a result of intensive investigation aimed at achieving the above object, the inventors of the present invention discovered that by using a specific vanadium compound and a specific aluminum compound, a vinyl chloride-based polymer having excellent thermal stability could be produced at a favorable level of productivity, and they were therefore able to complete the present invention.

Thus, the present invention provides a method of producing a vinyl chloride-based polymer that includes conducting a polymerization reaction of a vinyl chloride-based monomer in the presence of at least one vanadium compound (A) represented by a general formula shown below:

Vⁱ(═O)ⱼZₖ

(wherein i is an integer of 2 to 5 that represents the oxidation number of the vanadium atom, j represents either 0 or 1, Z represents a ligand, and is an organic ligand that can bond to the vanadium atom via a hetero atom, a halogen ligand, a monocyclic hydrocarbon ligand that may be substituted, or a polycyclic hydrocarbon ligand that may be substituted, a plurality of ligands Z may be the same or different and two or more ligands Z may be bonded together to form a ring that also includes the vanadium atom within the above formula as a member of the ring, and k is an integer of 1 to 5 that represents the number of ligands), and in the presence of at least one aluminum compound (B).

The production method of the present invention enables a vinyl chloride-based polymer having particularly superior thermal stability to be produced with favorable efficiency, and therefore has an extremely high industrial value. In addition, according to the method, the amount of an aluminoxane used is markedly small as compared with the prior art technology.

### DETAILED DESCRIPTION OF THE PREFERRED EMBODIMENTS

### Vanadium Compound

The vanadium compound used in the present invention is a vanadium compound represented by the above general formula (1). This vanadium compound may be either a single compound or a combination of two or more different compounds.

In the organic ligand that can bond to the vanadium atom via a hetero atom, represented by the ligand Z in general formula (1), examples of the hetero atom include an oxygen atom, a sulfur atom and a nitrogen atom. Specific examples of the organic ligand that can bond to the vanadium atom via a hetero atom include alkoxy ligands such as a methoxy ligand, ethoxy ligand, n-propoxy ligand, isopropoxy ligand, n-butoxy ligand or isobutoxy ligand, aryloxy ligands such as a phenoxy ligand or naphthoxy ligand, as well as an acetylacetone ligand, carboxylate ligand, salicylaldimine ligand, salen ligand or porphyrin ligand. These ligands may be substituted. Of the above ligands, an alkoxy ligand, aryloxy ligand, salicylaldimine ligand or salen ligand is preferred, and these ligands may be substituted.

Further, examples of the halogen ligand represented by the ligand Z in general formula (1) include a fluorine ligand, chlorine ligand or bromine ligand.

Moreover, examples of the monocyclic hydrocarbon ligand or polycyclic hydrocarbon ligand, either of which may be substituted, represented by the ligand Z in general formula (1) include a cyclopentadienyl ligand, indenyl ligand or fluorenyl ligand. In terms of enhancing the catalytic activity, k is preferably either 4 or 5.

In this description, the term “catalytic activity” describes the activity of the vanadium compound as a catalyst, and is defined as the mass of the vinyl chloride-based polymer produced per 1 mol of the vanadium compound per unit of time.

Of the vanadium compounds described above, vanadium (V) oxytrialkoxides such as vanadium (V) oxytriethoxide, vanadium (V) oxysalen and vanadium (IV) oxysalen are preferred, wherein any of these compounds may be substituted.

In the present invention, although there are no particular restrictions on the concentration of the organovanadium compound within the polymerization system, the vanadium metal concentration is typically within a range from 0.01 to 100 mmol/L, and is preferably from 1 to 10 mmol/L. If this concentration is too low, then the yield tends to decrease. In contrast, if the concentration is too high, then the effect of the vanadium compound in increasing the polymerization activity, the polymerization rate and the polymerization yield tends to become saturated, and the productivity tends to suffer.

### Aluminum Compound

The aluminum compound in the present invention is preferably at least one aluminum compound selected from the group consisting of aluminum compounds represented by general formula AlX₃ (wherein each X independently represents a halogen atom, an alkyl group that may be substituted, an aryl group that may be substituted, an alkoxy group that may be substituted, or an aryloxy group that may be substituted), cyclic aluminoxanes having a structure represented by general formula {—Al(R¹)O—}ₚ (wherein each R¹ independently represents an alkyl group that may be substituted, and p represents an integer of 1 or greater), and linear aluminoxanes having a structure represented by general formula R¹{—Al(R²)O—}_{q}AlR²₂ (wherein each R² independently represents an alkyl group that may be substituted, and q represents an integer of 1 or greater).

Specific examples of the aluminum compounds represented by general formula AlX₃ include trialkylaluminums such as trimethylaluminum, triethylaluminum and triisobutylaluminum.

Specific examples of the groups R¹ and R² in the cyclic aluminoxanes having a structure represented by general formula {—Al(R¹)O—}ₚ and the linear aluminoxanes having a structure represented by general formula R²{—Al(R²)O—}_{q}AlR²₂ respectively include alkyl groups such as a methyl, ethyl, n-propyl, isopropyl, n-butyl, isobutyl, n-pentyl or neopentyl group. p and q each represents an integer of 1 or greater, and is preferably an integer of 1 to 40. In particularly preferred compounds, R¹ and R² represent methyl, ethyl, propyl and/or isobutyl groups, and p and q each represent an integer of 3 to 20. However, Al—O—Al linkages constituting the backbone chain of the molecule of an aluminoxane is relatively readily cleaved or formed; thus, with a lapse of time or by being heated, a cyclic structure is likely to be changed to a linear structure, and a linear structure is likely to be changed to a cyclic structure, and p and q in the formulas stated above are also likely to be changed. Consequently, an aluminoxane is normally present in a state of a mixture of molecules having cyclic structures and molecules having linear structures with a variety of chain lengths, and therefore it is difficult to specify the structure of an aluminoxane unambiguously.

Of the above aluminoxanes, methylaluminoxanes in which R¹ or R² stated above are methyl groups are particularly preferred. A methylaluminoxane is normally a mixture of methylaluminoxane molecules with cyclic structures and methylaluminoxane molecules with linear structures.

In consideration of the catalytic activity, the concentration of the above aluminum compound, reported as a molar ratio relative to the vanadium atoms within the above organovanadium compound, is adjusted such that the molar ratio of aluminum atoms/vanadium atoms is typically within a range from 0.1 to 100, and preferably from 0.5 to 10. If this molar ratio is too small or too large, then the yield and the catalytic activity tend to deteriorate.

The production method of the present invention can be conducted using a typically polymerization system such as a bulk polymerization method or a solution polymerization method. Further, there are no particular restrictions on the solvent used in the case of a solution polymerization, and conventional solvents may be used, including alkanes and cyclolalkanes such as n-pentane, n-hexane, n-heptane, n-octane, n-isooctane, cyclohexane and methylcyclohexane, alkyl aromatic hydrocarbons such as toluene, xylene, ethylbenzene, and mono- or dialkylnaphthalenes, halogenated hydrocarbons such as chloromethane, methylene chloride, chloroform, carbon tetrachloride, 1,2-dichloroethane, chlorobenzene, chloronaphthalene and ortho-dichlorobenzene, hydrogenated aromatic hydrocarbons such as tetrahydronaphthalene and decahydronaphthalene, high-molecular weight liquid paraffin, and mixtures of the above solvents. Of these solvents, halogenated hydrocarbons tend to enhance the yield and the catalytic efficiency, and are therefore preferred.

Here, the term “catalytic efficiency” refers to the efficiency of the vanadium compound as a catalyst, and is defined as the number of mols of the vinyl chloride-based polymer generated per 1 mol of the vanadium compound.

There are no particular restrictions on the polymerization temperature, which may be selected, for example, within a range from −78° C. to 100° C. Furthermore, there are no particular restrictions on the polymerization reaction pressure.

The “vinyl chloride-based monomer” that represents the starting material for the polymerization conducted via the production method of the present invention may be either lone vinyl chloride monomer or a mixture of the vinyl chloride monomer and another vinyl-based monomer that is able to undergo copolymerization with the vinyl chloride monomer. Examples of the other vinyl-based monomer that is able to undergo copolymerization with the vinyl chloride monomer include olefin compounds such as ethylene and propylene, vinyl esters such as vinyl acetate and vinyl propionate, unsaturated monocarboxylic acids such as acrylic acid and α-alkylacrylic acids, and alkyl esters or amides thereof, unsaturated nitriles such as acrylonitrile, unsaturated dicarboxylic acids such as maleic acid and fumaric acid, and alkyl esters, acid anhydrides or N-substituted maleimides thereof, vinyl alkyl ethers such as vinyl methyl ether and vinyl ethyl ether, vinylidene compounds such as vinylidene chloride, conjugated dienes such as butadiene and isoprene, non-conjugated dienes such as 1,5-hexadiene and 1,4-pentadiene, cycloolefins such as cyclohexene and norbornene, vinyl aromatic compounds such as styrene, styrene derivatives and N-vinylcarbazole, and carbon oxides such as carbon monoxide.

Furthermore, additives typically used in the polymerization of vinyl chloride-based monomers, including thermal stability improvers, workability improvers and other improvers, may be added to the polymerization system as required.

The vinyl chloride-based polymer obtained using the present invention can be used in any of the conventional applications for vinyl chloride-based polymers, including as molding materials for films and sheets and the like.

### Examples

A more detailed description of the present invention is presented below based on a series of examples, although the present invention is in no way limited by these examples. Descriptions of the monomers and the like used in the examples and comparative examples, as well as descriptions of the methods used for measuring and calculating the yield and other properties, are presented below.

Vinyl Chloride Monomer

The vinyl chloride monomer (hereafter abbreviated as VCM) was a commercially available product.

Vanadium Compounds

For the vanadium (V) oxytriethoxide, a commercially available product was used without purification.

V compound 1 (Example 9) was synthesized in accordance with the document “Journal of the American Chemical Society, 108 (1986), 4088 to 4095”, and was then purified prior to use.

V compound 2 (Example 10) was synthesized in accordance with the document “Bulletin of the Chemical Society of Japan, 77 (2004), 1849 to 1854”, and was then purified prior to use.

Aluminum Compounds—Radical Initiator

For the aluminum compounds and the radical initiator, commercially available products were used without purification.

Polymerization Solvent

The polymerization solvent was purified over calcium hydride prior to use.

Yield of Vinyl Chloride Polymer

The yield was calculated from the dry mass of the obtained vinyl chloride polymer.

Calculation of Catalytic Efficiency

Catalytic efficiency(%)={[VCM (mol/L)]×(yield(%)÷100)×62.5}÷{[transition metal(mol/L)]×number average molecular weight(Mn)}×100

Method of Calculating Catalytic Activity

Catalytic activity(g−PVC/mol−transition metal·h)={[VCM(mol/L)]×(yield (%)÷100)×62.5}÷{[transition metal(mol/L)]×polymerization time(h)}

Measurement of Number Average Molecular Weight and Weight Average Molecular Weight of Vinyl Chloride Polymer

The polystyrene-referenced number average molecular weight (Mn) and weight average molecular weight (Mw) of the obtained vinyl chloride polymer were measured using a gel permeation chromatograph (manufactured by Tosoh Corporation) with tetrahydrofuran as the solvent.

The ratio Mw/Mn was recorded as the molecular weight distribution.

Thermal Decomposition Temperature of Vinyl Chloride Polymer

Using a thermogravimetric analyzer (product name: TG/DTA 6200, manufactured by Seiko Instruments Inc.), the temperature at which a 5% mass loss occurred was measured under a nitrogen gas flow and at a rate of temperature increase of 10° C./min., and this temperature was recorded as the thermal decomposition temperature for the vinyl chloride polymer.

### Example 1

A glass reaction vessel that had been flushed with nitrogen was charged with 7 mL of vanadium (V) oxytriethoxide diluted with n-hexane (14.3 mmol/L) and 1 mL of trimethylaluminum diluted with n-hexane (0.1 mol/L). Subsequently, 2 mL (30 mmol) of vinyl chloride monomer (VCM) obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 2

With the exception of using triethylaluminum instead of the trimethylaluminum used in Example 1, polymerization was conducted in the same manner as Example 1.

The polymerization conditions and the results of evaluating the obtained vinyl chloride polymer are shown in Table 1 and Table 2 respectively.

### Example 3

With the exception of using triisobutylaluminum instead of the trimethylaluminum used in Example 1, polymerization was conducted in the same manner as Example 1.

The polymerization conditions and the results of evaluating the obtained vinyl chloride polymer are shown in Table 1 and Table 2 respectively.

### Example 4

A glass reaction vessel that had been flushed with nitrogen was charged with 7 mL of vanadium (V) oxytriethoxide diluted with n-hexane (14.3 mmol/L) and 1 mL of methylaluminoxane (PMAO) (tradename: PMAO-S, produced by Tosoh Finechem Corp.) diluted with toluene (0.24 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 5

With the exception of changing the diluting solvent for the vanadium (V) oxytriethoxide from n-hexane to toluene, polymerization was conducted in the same manner as Example 3.

The polymerization conditions and the results of evaluating the obtained vinyl chloride polymer are shown in Table 1 and Table 2 respectively.

### Example 6

With the exception of changing the diluting solvent for the vanadium (V) oxytriethoxide from n-hexane to carbon tetrachloride, polymerization was conducted in the same manner as Example 3.

The polymerization conditions and the results of evaluating the obtained vinyl chloride polymer are shown in Table 1 and Table 2 respectively.

### Example 7

A glass reaction vessel that had been flushed with nitrogen was charged with 7 mL of vanadium (V) oxytriethoxide diluted with methylene chloride (28.6 mmol/L) and 1 mL of triisobutylaluminum diluted with n-hexane (0.1 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 8

A glass reaction vessel that had been flushed with nitrogen was charged with 7 mL of vanadium (V) oxytriethoxide diluted with methylene chloride (14.3 mmol/L) and 1 mL of triisobutylaluminum diluted with n-hexane (0.1 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 9

A glass reaction vessel that had been flushed with nitrogen was charged with 7 mL of a methylene chloride-diluted solution of 1,2-ethylenediamino-N,N′-bis(3′,5′-di-tert-butylsalicylidene)oxo-vanadium (V) (abbreviated as “V compound 1” in Table 1) (1.43 mmol/L) represented by the formula shown below:

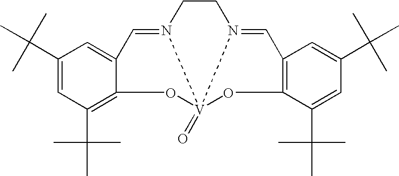

and 1 mL of triethylaluminum diluted with n-hexane (0.1 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 10

A glass reaction vessel that had been flushed with nitrogen was charged with 7 mL of a methylene chloride-diluted solution of 2-oxy-1,3 -propanediamino-N,N′-bis(3′,5′-di-tert-butylsalicylidene)oxo-vanadium (V) (abbreviated as “V compound 2” in Table 1) (1.43 mmol/L) represented by the formula shown below:

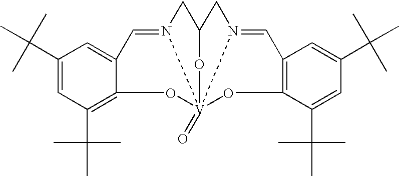

and 1 mL of triethylaluminum diluted with n-hexane (0.1 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Comparative Example 1

A glass reaction vessel that had been flushed with nitrogen was charged with 8 mL of vanadium (V) oxytriethoxide diluted with methylene chloride (12.5 mmol/L), 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the polymerization reaction mixture was poured into a large volume of methanol containing 5 vol % of hydrochloric acid.

The polymerization conditions and the results of evaluating the obtained vinyl chloride polymer are shown in Table 1 and Table 2 respectively.

### Comparative Example 2

A glass reaction vessel that had been flushed with nitrogen was charged with 8 mL of triisobutylaluminum diluted with methylene chloride (12.5 mmol/L), 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at 50° C. to initiate the polymerization. Once the reaction had proceeded for 24 hours, the polymerization reaction mixture was poured into a large volume of methanol containing 5 vol % of hydrochloric acid.

The polymerization conditions and the results of evaluating the obtained vinyl chloride polymer are shown in Table 1 and Table 2 respectively.

### Comparative Example 3

A glass reaction vessel that had been flushed with nitrogen was charged with 2 mL of triphenoxy(pentamethylcyclopentadienyl)titanium diluted with toluene (15 mmol/L) and 1 mL of methylaluminoxane (PMAO) (tradename: PMAO-S, produced by Tosoh Finechem Corp.) diluted with toluene (0.3 mol/L). Following aging for 10 minutes at room temperature, the toluene was removed under a high vacuum. Subsequently, 8 mL of methylene chloride and 2 mL (30 mmol) of vinyl chloride monomer obtained by vacuum distillation over calcium hydride at −78° C. were added to the reaction vessel, and the reaction vessel was then heat-sealed under vacuum and immersed in a constant temperature bath at 50° C. to initiate the polymerization. Once the reaction had proceeded for 48 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 1 and Table 2 respectively.

### Example 11

A glass reaction vessel that had been flushed with nitrogen was charged with 7 mL of vanadium (V) oxytriethoxide diluted with n-hexane (14.3 mmol/L) and 1 mL of triisobutylaluminum diluted with n-hexane (0.1 mol/L). Subsequently, 2 mL (30 mmol) of vinyl chloride monomer obtained by vacuum distillation over calcium hydride at −78° C. was added to the reaction vessel, and the reaction vessel was then heat-sealed under vacuum and immersed in a constant temperature bath at −25° C. to initiate the polymerization. Once the reaction had proceeded for 24 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 3 and Table 4 respectively.

### Comparative Example 4

A glass reaction vessel that had been flushed with nitrogen was charged with 0.379 mmol of lauroyl peroxide (a radical initiator) and 152 mmol of vinyl chloride monomer obtained by vacuum distillation over calcium hydride at −78° C. The total volume was 10 mL. The reaction vessel was heat-sealed under vacuum, and then immersed in a constant temperature bath at 30° C. to initiate the polymerization. Once the reaction had proceeded for 12 hours, the vinyl chloride polymer was recovered by pouring the polymerization reaction mixture into a large volume of methanol containing 5 vol % of hydrochloric acid.

The polymerization conditions and the results of evaluating the obtained vinyl chloride polymer are shown in Table 3 and Table 4 respectively.

TABLE 1

| | | | Vanadium | Aluminum | | | | |
|---|---|---|---|---|---|---|---|---|
| | | VCM | compound | compound | | Polymerization | Polymerization | Polymerization |
| | | (mol/L) | (mol/L) | (mol/L) | Al/V or Ti | solvent | temperature (° C.) | time (h) |
| Example | 1 | 3.0 | VO(OEt₃) | Me₃Al | 1 | Hexane | 50 | 24 |
| | | | 0.01 | 0.01 | | | | |
| | 2 | 3.0 | VO(OEt₃) | Et₃Al | 1 | Hexane | 50 | 24 |
| | | | 0.01 | 0.01 | | | | |
| | 3 | 3.0 | VO(OEt₃) | i-Bu₃Al | 1 | Hexane | 50 | 24 |
| | | | 0.01 | 0.01 | | | | |
| | 4 | 3.0 | VO(OEt₃) | PMAO | 2.4 | Hexane | 50 | 24 |
| | | | 0.01 | 0.024 | | | | |
| | 5 | 3.0 | VO(OEt₃) | i-Bu₃Al | 1 | Toluene | 50 | 24 |
| | | | 0.01 | 0.01 | | | | |
| | 6 | 3.0 | VO(OEt₃) | i-Bu₃Al | 1 | Carbon | 50 | 24 |
| | | | 0.01 | 0.01 | | tetrachloride | | |
| | 7 | 3.0 | VO(OEt₃) | i-Bu₃Al | 0.5 | Methylene | 50 | 24 |
| | | | 0.02 | 0.01 | | chloride | | |
| | 8 | 3.0 | VO(OEt₃) | i-Bu₃Al | 1 | Methylene | 50 | 24 |
| | | | 0.01 | 0.01 | | chloride | | |
| | 9 | 3.0 | V compound 1 | Et₃Al | 10 | Methylene | 50 | 24 |
| | | | 0.001 | 0.01 | | chloride | | |
| | 10 | 3.0 | V compound 2 | Et₃Al | 10 | Methylene | 50 | 24 |
| | | | 0.001 | 0.01 | | chloride | | |
| Comparative | 1 | 3.0 | VO(OEt₃) | — | 0 | Methylene | 50 | 24 |
| Example | | | 0.01 | — | | chloride | | |
| | 2 | 3.0 | — | i-Bu₃Al | — | Methylene | 50 | 24 |
| | | | — | 0.1 | | chloride | | |
| | 3 | 3.0 | Ti | PMAO | 10 | Methylene | 50 | 48 |
| | | | 0.003 | 0.03 | | chloride | | |

TABLE 2

| | | | Number average | Molecular weight | Catalytic | |
|---|---|---|---|---|---|---|
| | | Yield | molecular weight | distribution | efficiency | Catalytic activity |
| | | (%) | (Mn) | (Mw/Mn) | (%) | (g-PVC/mol-M · h) |
| Example | 1 | 36.6 | 18,000 | 1.9 | 38 | 286 |
| | 2 | 63.6 | 21,000 | 1.9 | 57 | 497 |
| | 3 | 48.3 | 16,000 | 2.1 | 57 | 377 |
| | 4 | 21.3 | 10,000 | 2.3 | 40 | 166 |
| | 5 | 28.4 | 10,000 | 1.6 | 53 | 222 |
| | 6 | 55.7 | 7,000 | 1.6 | 149 | 435 |
| | 7 | 67.9 | 12,000 | 1.9 | 53 | 265 |
| | 8 | 60.7 | 11,000 | 1.9 | 103 | 474 |
| | 9 | 5.9 | 18,000 | 2.0 | 61 | 461 |
| | 10 | 15.4 | 13,000 | 2.0 | 222 | 1203 |
| Comparative | 1 | 0 | — | — | — | — |
| example | 2 | trace | — | — | — | — |
| | 3 | 3.5 | 21,000 | 3.7 | 10 | 46 |

TABLE 3

| | | | Vanadium compound . | | | | |
|---|---|---|---|---|---|---|---|
| | | | Al compound . | | | Polymerization | |
| | | VCM | radical initiator | | Polymerization | temperature | Polymerization |
| | | (mol/L) | (mol/L) | | solvent | (° C.) | time (h) |
| Example | 11 | 3.0 | VO(OEt₃) | i-Bu₃Al | Hexane | 20 | 24 |
| | | | 0.01 | 0.01 | | | |

| | | | | | | |
|---|---|---|---|---|---|---|
| Comparative | 4 | 15.2 | LPO (radical initiator) | None | 30 | 12 |
| Example | | | 0.0379 | | | |

TABLE 4

| | | | Number | | |
|---|---|---|---|---|---|
| | | | average | Molecular | Thermal |
| | | | molecular | weight | decomposition |
| | | Yield | weight | distribution | temperature |
| | | (%) | (Mn) | (Mw/Mn) | (° C.) |
| Example | 11 | 31.1 | 20,000 | 2.7 | 284 |
| Comparative | 4 | 19.6 | 130,000 | 2.8 | 263 |
| Example | | | | | |

What is claimed is:

1. A method of producing a vinyl chloride-based polymer, comprising conducting a polymerization reaction of a vinyl chloride-based monomer in presence of at least one vanadium compound (A) represented by the general formula:
Vⁱ(═O)ⱼZₖ
wherein i is an integer of 2 to 5 that represents an oxidation number of a vanadium atom, j represents either 0 or 1, Z represents a ligand, which is an organic ligand that can bond to the vanadium atom via a hetero atom, a halogen ligand, an unsubstituted or substituted monocyclic hydrocarbon ligand, or an unsubstituted or substituted polycyclic hydrocarbon ligand, and k is an integer from 1 to 5 that represents a number of ligands, provided that when a plurality of ligands Z are present, they may be identical or different, and two or more ligands Z may be bonded together to form a ring that also includes the vanadium atom within the general formula as a member of the ring, and in presence of at least one aluminum compound (B).

2. The method of producing a vinyl chloride-based polymer according to claim 1, wherein Z within the vanadium compound (A) is at least one type of ligand selected from the group consisting of unsubstituted or substituted alkoxy ligands, unsubstituted or substituted aryloxy ligands, unsubstituted or substituted salicylaldimine ligands and unsubstituted or substituted salen ligands.

3. The method of producing a vinyl chloride-based polymer according to claim 1, wherein the vanadium compound (A) is at least one compound selected from the group consisting of unsubstituted or substituted vanadium (V) oxytrialkoxides, unsubstituted or substituted vanadium (V) oxysalens and unsubstituted or substituted vanadium (IV) oxysalens.

4. The method of producing a vinyl chloride-based polymer according to claim 1, wherein the aluminum compound (B) is at least one compound selected from the group consisting of aluminum compounds represented by general formula AlX₃, wherein each X independently represents a halogen atom, an unsubstituted or substituted alkyl group, an unsubstituted or substituted aryl group, an unsubstituted or substituted alkoxy group, or an unsubstituted or substituted aryloxy group, cyclic aluminoxanes represented by general formula {—Al(R¹)O—}ₚ, wherein each R¹ independently represents an unsubstituted or substituted alkyl group, and p represents an integer of 1 or greater, and linear aluminoxanes represented by general formula R²{—Al(R²)O—}_{q}AlR²₂, wherein each R² independently represents an unsubstituted or substituted alkyl group, and q represents an integer of 1 or greater.

5. The method of producing a vinyl chloride-based polymer according to claim 1, wherein t-he aluminum compound (B) is at least one compound selected from the group consisting of trimethylaluminum, triethylaluminum, triisobutylaluminum and methylaluminoxanes.

6. The method of producing a vinyl chloride-based polymer according to claim 1, wherein the polymerization is conducted in bulk or within a solvent.

7. The method of producing a vinyl chloride-based polymer according to claim 1, wherein the polymerization is conducted within a solvent, and the solvent is at least one solvent selected from the group consisting of toluene, n-hexane, methylene chloride and carbon tetrachloride.

8. The method of producing a vinyl chloride-based polymer according to claim 1, wherein the polymerization is conducted within a solvent, and the solvent is a halogenated hydrocarbon.
